(19) United States
(12) Patent Application Publication
(10) Pub. No.: US 2009/0249356 A1
(43) Pub. Date: Oct. 1, 2009

(54) LOCK-FREE CIRCULAR QUEUE IN A MULTIPROCESSING SYSTEM

(76) Inventors: Xin He, Shanghai (CN); Qi Zhang, Shanghai (CN)

Correspondence Address: Larry Mennemeier;Interl Corporation, c/o Intellevate, LLC, P.O. Box 52050, Minneapolis, MN, 55402, US

(21) Appl. No.: 12/060,231

(22) Filed: Mar. 31, 2008

(51) Int. Cl. G06F 13/00

(52) U.S. Cl. 719/314

(57) ABSTRACT

Lock-free circular queues relying only on atomic aligned read/write accesses in multiprocessing systems are disclosed. In one embodiment, when comparison between a queue tail index and each queue head index indicates that there is sufficient room available in a circular queue for at least one more queue entry, a single producer thread is permitted to perform an atomic aligned write operation to the circular queue and then to update the queue tail index. Otherwise an enqueue access for the single producer thread would be denied. When a comparison between the queue tail index and a particular queue head index indicates that the circular queue contains at least one valid queue entry, a corresponding consumer thread may be permitted to perform an atomic aligned read operation from the circular queue and then to update that particular queue head index. Otherwise a dequeue access for the corresponding consumer thread would be denied.

### FIELD OF THE DISCLOSURE

This disclosure relates generally to the field of multiprocessing. In particular, the disclosure relates to a lock-free circular queue for inter-thread communication in a multiprocessing system.

### BACKGROUND OF THE DISCLOSURE

In multiprocessing and/or multithreaded applications, queue structures may be used to exchange data between processors and/or execution threads in a first-in-first-out (FIFO) manner. A producer thread may enqueue or write data to the queue and a consumer thread (or multiple consumer threads) may dequeue or read the data from the queue.

For example, a task distribution mechanism may make use of queues to achieve load balancing between multiple processors and/or execution threads by employing the queues as part of a task-push mechanism. In such an environment, processors and/or execution threads may produce tasks for other processors and/or execution threads. The tasks are pushed (enqueued) onto a queue for the other processors and/or execution threads to fetch (dequeue). It will be appreciated that a high performance queue implementation may be required in order to avoid the queue becoming a bottleneck of such a multiprocessing system.

Sharing a queue between a producer and a consumer can introduce race conditions unless the queue length is unlimited. Sometimes, a producer and a consumer may use a lock mechanism to resolve such race conditions, but lock mechanisms may introduce performance degradation and scalability issues.

One type of fine-grained lock-free mechanism uses an atomic compare-and-swap (CAS) operation to support concurrent queue access in shared-memory multiprocessing systems. A drawback to such a CAS-based queue structure is that while a dequeue requires only one successful CAS operation, an enqueue may require two successful CAS operations, which increases the chance of a failed enqueue. Furthermore a CAS operation, which requires exclusive ownership and flushing of the processor write buffers, could again introduces performance degradation and scalability issues.

Another approach uses thread scheduler coordination, e.g. as in Linux, to serialize multithread access to the queue, which may also introduce performance degradation and scalability issues. To date, more efficient lock-free queue structures for inter-thread communication in multiprocessing systems have not been fully explored.

### BRIEF DESCRIPTION OF THE DRAWINGS

The present invention is illustrated by way of example and not limitation in the figures of the accompanying drawings.

FIG. 1 illustrates one embodiment of a multiprocessing system using a lock-free circular queue for inter-thread communication.

FIG. 2a illustrates an alternative embodiment of a multiprocessing system using lock-free circular queues for inter-thread communication.

FIG. 2b illustrates another alternative embodiment of a multiprocessing system using lock-free circular queues for inter-thread communication.

FIG. 3 illustrates a flow diagram for one embodiment of a process to use a lock-free circular queue for inter-thread communication.

FIG. 4 illustrates a flow diagram for an alternative embodiment of a process to use a lock-free circular queue for inter-thread communication.

### DETAILED DESCRIPTION

Methods and apparatus for inter-thread communication in a multiprocessing system are disclosed. In one embodiment, when a comparison between a queue tail index and each queue head index indicates that there is sufficient room available in a circular queue for at least one more queue entry, a single producer thread is permitted to perform an atomic aligned write operation to the circular queue and then to update a queue tail index. Otherwise queue access for the single producer thread is denied. When a comparison between the queue tail index and a particular queue head index indicates that the circular queue contains at least one valid queue entry, a corresponding consumer thread may be permitted to perform an atomic aligned read operation from the circular queue and then to update that particular queue head index. Otherwise queue access for the corresponding consumer thread is denied. In alternative embodiments, when a comparison between the queue tail index and another queue head index indicates that the circular queue contains at least one valid queue entry, another corresponding consumer thread may also be permitted to perform an atomic aligned read operation from the circular queue and then to update its corresponding queue head index. Similarly, queue access for that corresponding consumer thread is denied otherwise.

Thus, such lock-free circular queues may rely only upon atomic aligned read/write accesses in a multiprocessing system, thereby avoiding critical sections, special purpose atomic primitives and/or thread scheduler coordination. Through a reduced overhead in queue access, and inherent hardware enforcement of atomic aligned read/write accesses, a higher performance level is achieved for inter-thread communication in the multiprocessing system.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than a restrictive sense and the invention measured only in terms of the claims and their equivalents.

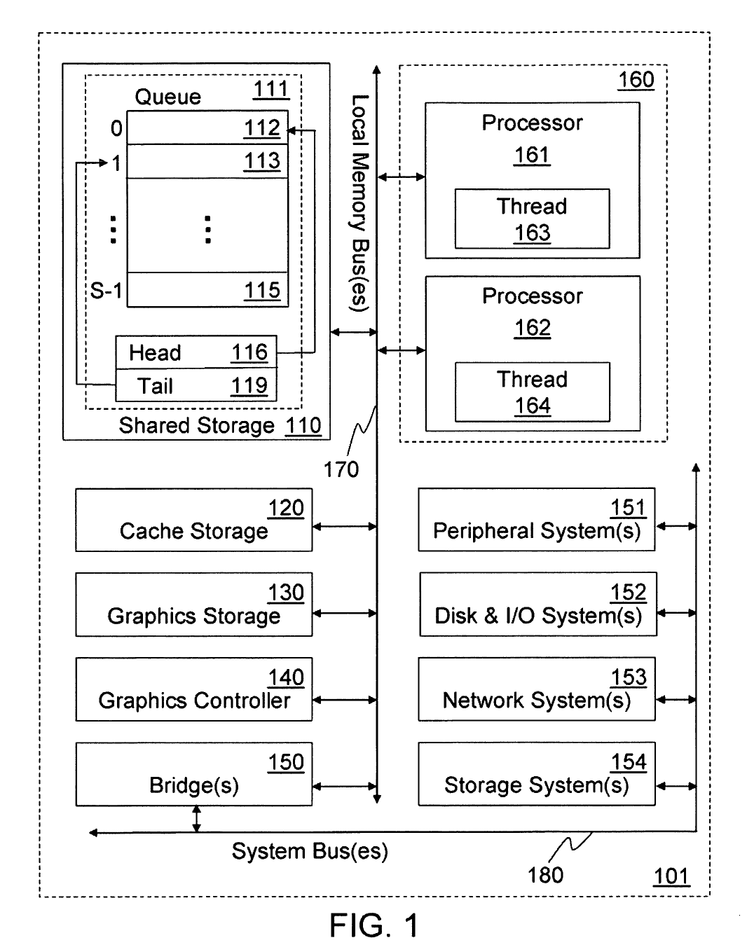

FIG. 1 illustrates one embodiment of a multiprocessing system 101 using a lock-free circular queue for inter-thread communication. Multiprocessing system 101 includes local memory bus(ses) 170 coupled with an addressable memory 110 to store data 112-115 in a circular queue 11 including queue tail index 119 and queue head index 116, and also to store machine executable instructions for accessing the circular queue 111.

Multiprocessing system 101 further includes cache storage 120, graphics storage 130, graphics controller 140 and bridge(s) 150 coupled with local memory bus(ses) 170. Bridge(s) 150 are also coupled via system bus(ses) 180 with peripheral system(s) 151, disk and I/O system(s) 152 such as magnetic storage devices to store a copy of the machine executable instructions for accessing the circular queue 111, network system(s) 153, and other storage system(s) 154 such as flash memory and/or backup storage.

Multiprocessing system 101 further includes multiprocessor 160, which for example, may include a producer thread 163 of processor 161 and a consumer thread 164 of processor 162. Multiprocessor 160 is operatively coupled with the addressable memory 10 and being responsive to the machine executable instructions for accessing the circular queue 111, for example, permits the producer thread 163 to perform an atomic aligned write operation via local memory bus(ses) 170 to circular queue 111 and then to update queue tail index 119 whenever a comparison between queue tail index 119 and queue head index 116 indicates that there is sufficient room available in the queue for at least one more queue entry, i.e. at entry 1, but denies the producer thread 163 an enqueue access to queue 111 otherwise. One embodiment of queue 111 would indicate that queue 111 has insufficient room available for at least one more queue entry when incrementing the circular queue tail index 119 would make it equal to the queue head index 116 modulo the queue size.

By way of further example, multiprocessor 160 being responsive to the machine executable instructions for accessing the circular queue 111, also permits the consumer thread 164 to perform an atomic aligned read operation from the circular queue and to update queue head index 116 whenever a comparison between the queue tail index 119 and queue head index 116 indicates that the queue 111 contains at least one valid queue entry, e.g. entry 0, but denies the consumer thread 164 a dequeue access from queue 111 otherwise. For example, one embodiment of queue 111 indicates that queue 111 contains no valid queue entry when queue tail index 119 and queue head index 116 are equal.

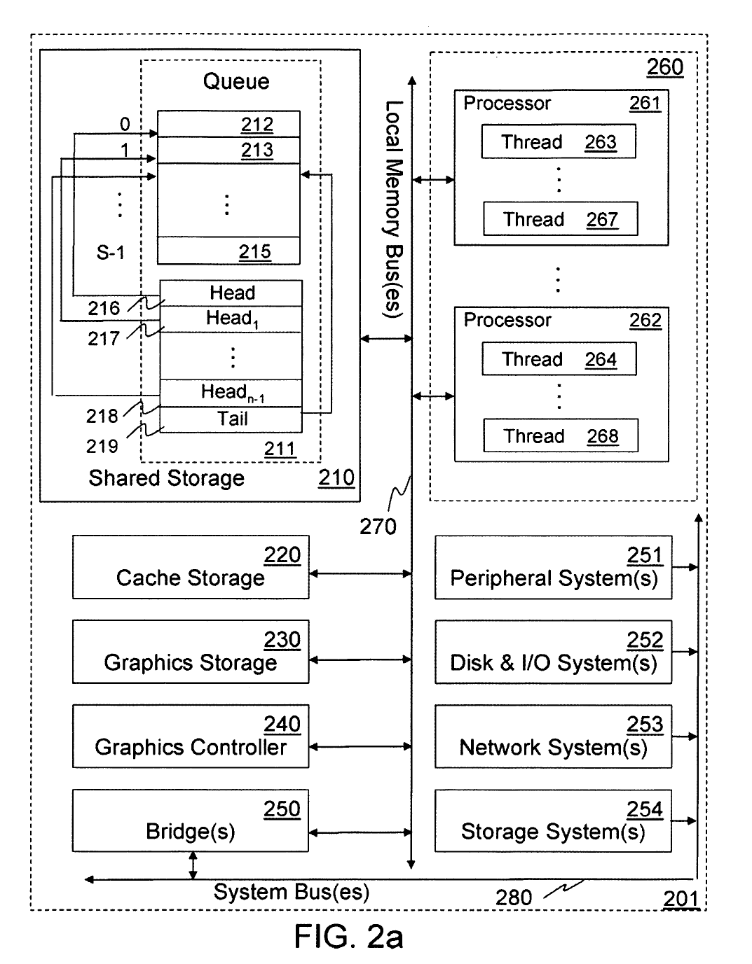

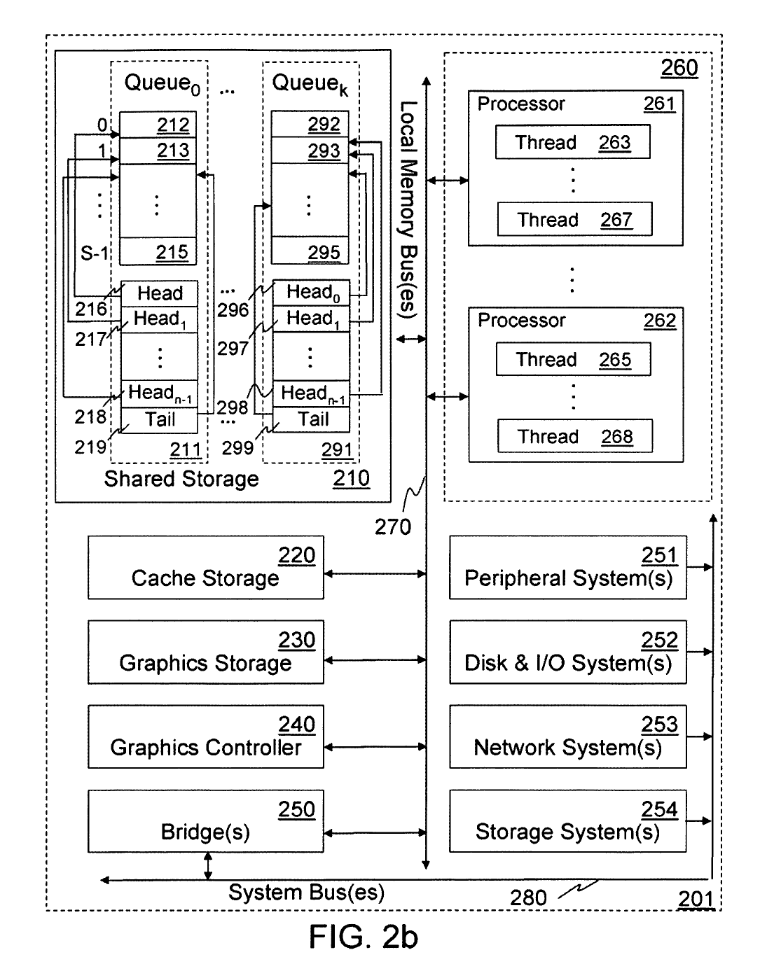

FIG. 2a illustrates an alternative embodiment of a multiprocessing system 201 using a lock-free circular queue 211 for inter-thread communication. Multiprocessing system 201 includes local memory bus(ses) 270 coupled with an addressable memory 210 to store data in circular queue 211 including queue tail indicex 219 and one or more queue head indices 216-218. Addressable memory 210 also stores machine executable instructions for accessing the circular queue 211.

Multiprocessing system 201 further includes cache storage 220, graphics storage 230, graphics controller 240 and bridge(s) 250 coupled with local memory bus(ses) 270. Bridge(s) 250 are also coupled via system bus(ses) 280 with peripheral system(s) 251, disk and I/O system(s) 252 such as magnetic storage devices to store a copy of the machine executable instructions for accessing the circular queue 211, network system(s) 253, and other storage system(s) 254.

Multiprocessing system 201 further includes multiprocessor 260, which for example, may include producer thread 263 of processor 261 and consumer threads 267 and 264-268 of processors 261 and 262 respectively. Multiprocessor 260 is operatively coupled with the addressable memory 210 and being responsive to the machine executable instructions for accessing the circular queue 211, for example, permits the producer thread 263 to perform atomic aligned write operations via local memory bus(ses) 170 to the circular queue 211 and then to update queue tail index 219 whenever comparisons between queue tail index 219 and each queue head index (216-218) indicates that there is sufficient room available in queue 211 for at least one more queue entry, but denies the producer thread 263 an enqueue access to queue 211 otherwise. One embodiment of queue 2111 would indicate that there is insufficient room available for at least one more queue entry whenever incrementing the circular queue tail index 219 would make it equal (modulo the queue size) to any of the queue head indices (Head₀-Headₙ₋₁) for the queue.

Further, multiprocessor 260, being responsive to the machine executable instructions for accessing circular queue 211, permits the consumer threads 267 and 264-268 to perform atomic aligned read operations from circular queue 211 and to update their respective queue head indices of indices 216-296 whenever a comparison between the queue tail index 219 and their respective queue head index indicates that the queue contains at least one valid queue entry, but denies the consumer threads 267 and 264-268 dequeue access to queue 211 otherwise.

FIG. 2b illustrates another alternative embodiment of a multiprocessing system 202 using lock-free circular queues 211-291 for inter-thread communication. Multiprocessing system 202 is like multiprocessing system 201 but with an addressable memory 210 to store data in circular queues 211-291 including queue tail indices 219-299 and one or more queue head indices 216-218 through 296-298. Addressable memory 210 also stores machine executable instructions for accessing the circular queues 211-291.

Multiprocessing system 202 further includes multiprocessor 260, which for example, may include producer threads 263 and 265 of processors 261 and 262 and consumer threads 267 and 268 of processors 261 and 262 respectively. Multiprocessor 260 is operatively coupled with the addressable memory 210 and being responsive to the machine executable instructions for accessing the circular queues 211-291, for example, permits the producer threads 263 or 265 to perform atomic aligned write operations via local memory bus(ses) 170 to their respective queues of the circular queues 211-291 and then to update their respective queue tail indices of the indices 219-299 whenever comparisons between their respective queue tail index (e.g. 219) and each queue head index (e.g. 216-218) indicates that there is sufficient room available in their respective queue (e.g. 211) of the queues 211-291 for at least one more queue entry, but denies the producer threads 263 or 265 an enqueue access to their respective queues of the queues 211-291 otherwise. One embodiment of queues 211-291 would indicate that there is insufficient room available for at least one more queue entry whenever incrementing the particular circular queue tail index 219-299 would make it equal (modulo the queue size) to any of the queue head indices (Head₀-Headₙ₋₁) for that particular queue.

Further, multiprocessor 260, being responsive to the machine executable instructions for accessing any of circular queues 211-291, permits the consumer threads 267 and 268 to perform atomic aligned read operations from any of the circular queues 211-291 and to update their respective queue head indices of indices 216-296 through 218-298 whenever a comparison between the particular queue tail index of indices 219-299 and their respective queue head index for that corresponding queue indicates that the queue contains at least one valid queue entry, but denies the consumer threads 267 and 268 access to queues 211-291 otherwise. For example, one embodiment of queue 211 indicates that queue 211 contains no valid queue entry for consumer threads 267 or 268 when the particular queue tail index 219 is equal to the queue head index for consumer thread 267 or for consumer thread 268 respectively.

Thus, the lock-free circular queues 211-291 rely only upon inherent atomic aligned read/write memory accesses in multiprocessing system 202, avoiding critical sections, special purpose atomic primitives and/or thread scheduler coordination. Through a reduced overhead in producer/consumer accesses to queue 211-291, and hardware enforcement of atomic aligned read/write accesses, a higher performance level is achieved for inter-thread communication in multiprocessing system 202.

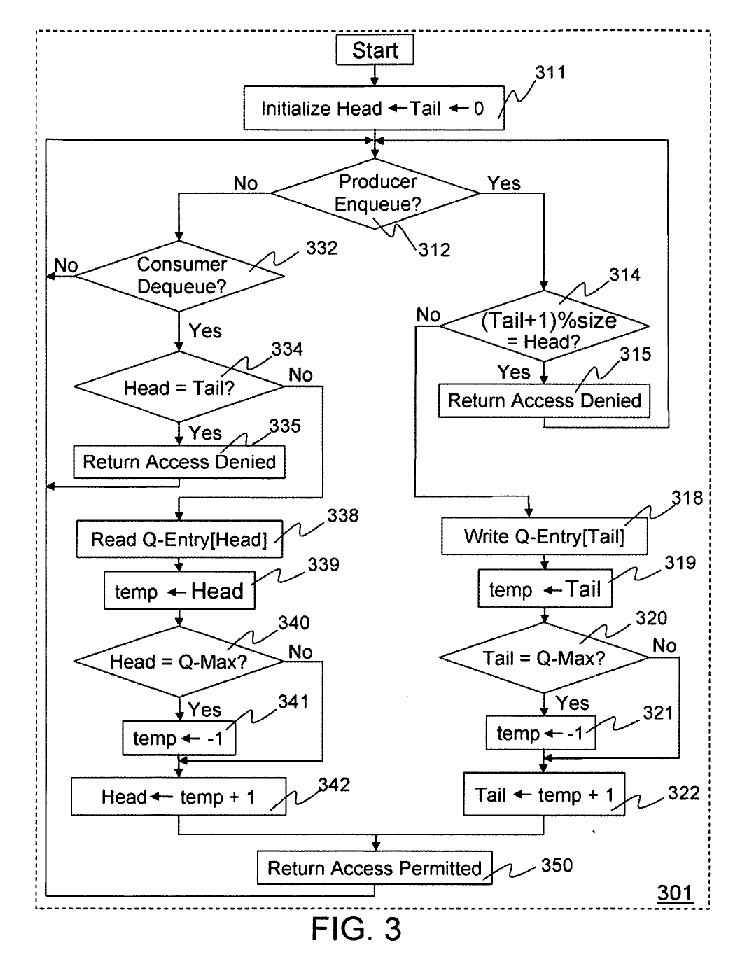

FIG. 3 illustrates a flow diagram for one embodiment of a process 301 to use a lock-free circular queue for inter-thread communication. Process 301 and other processes herein disclosed are performed by processing blocks that may comprise dedicated hardware of software or firmware operation codes executable by general purpose machines or by special purpose machines or by a combination of both.

In processing block 311 the head index and the tail index are initialized to zero. If in processing block 312 a producer thread is attempting to enqueue data, then processing proceeds to processing block 314. Otherwise processing proceeds to processing block 332 wherein it is determined if a consumer thread is attempting to dequeue data. Processing repeats in processing blocks 312 and 332 until one of these two cases is satisfied.

First, assuming that in processing block 312 a producer is attempting to enqueue data, then in processing block 314 a comparison is performed between the queue tail index and the queue head index to see if they differ by exactly one modulo the queue size and incrementing the tail index would cause a queue overflow, in which case the circular queue is already full. If the queue is not already full, the comparison in processing block 314 indicates that there is sufficient room available in the queue for at least one more queue entry, and so a single producer thread is permitted to perform an atomic write operation to an aligned queue entry in memory in processing block 318 and then to update the queue tail index starting in processing block 319. Otherwise the producer thread is denied queue access in processing block 315 and processing returns to processing block 312.

Now starting in processing block 319, one embodiment of updating the circular queue tail index begins with saving the tail value to a temporary storage, and in processing block 320, comparing the tail to see if it has reached the maximum queue index value. If so, the temporary storage value is reset to a value of minus one (−1) in processing block 321. Otherwise processing skips directly to processing block 322 where the temporary storage value is incremented and stored to the circular queue tail index, thus completing the update of the queue tail index with an atomic write operation. Then from processing block 350 processing returns to processing block 312 with an indication that an access to the queue has been permitted.

Next, assuming instead that in processing block 332 a consumer thread is attempting to dequeue data, then in processing block 334 a comparison is made between the queue tail index and the queue head index to see if they are equal, in which case the circular queue is empty and there is no valid entry to dequeue. If the queue is not empty, the comparison in processing block 334 would indicate that the queue contains at least one valid queue entry and so the consumer thread is permitted to perform an atomic read operation from an aligned entry in the circular queue in processing block 338 and to update the queue head index starting in processing block 339. Otherwise the consumer thread is denied a dequeue access in processing block 335 and processing returns to processing block 312.

Now starting in processing block 339, updating the circular queue head index begins with saving the head index value to a temporary storage and, in processing block 340, comparing the head index to see if it has reached the maximum queue index value. If so, the temporary storage value is reset to a value of minus one (−1) in processing block 341. Otherwise processing skips directly to processing block 342 where the temporary storage value is incremented and stored to the circular queue head index, thus completing the update of queue head index with an atomic write operation. Then from processing block 350 processing returns to processing block 312 with an indication that an access to the queue has been permitted. It will be appreciated that while updating head and tail indices in process 301 and other processes herein disclosed may be modified by those skilled in the art, when such an update occurs through a single atomic write operation, such modification is made without departing from the principles of the present invention.

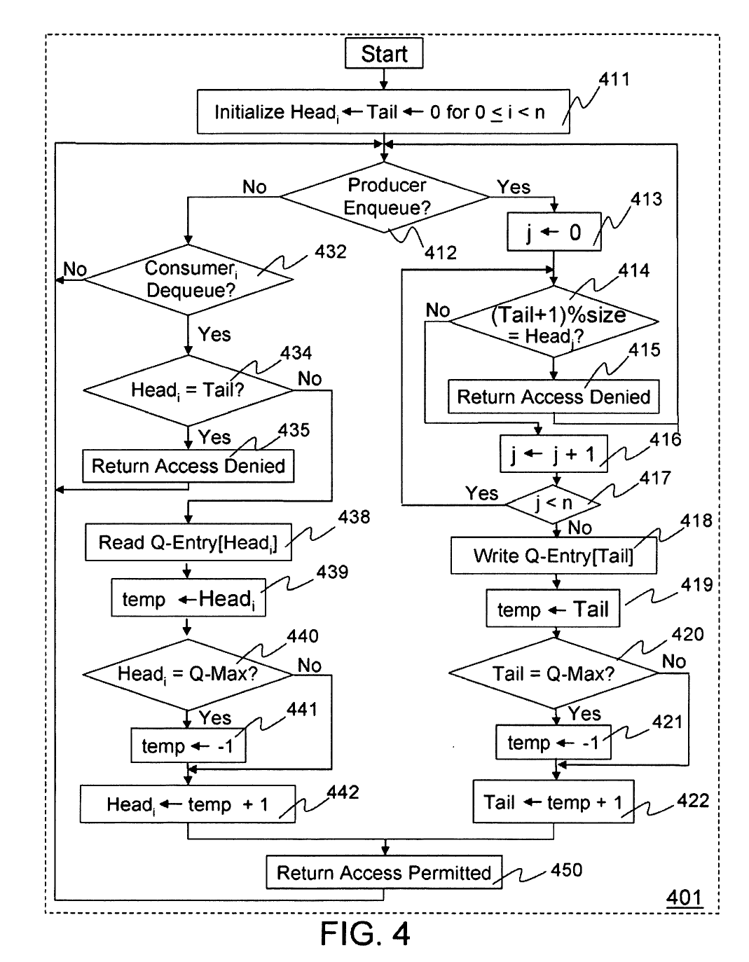

FIG. 4 illustrates a flow diagram for an alternative embodiment of a process 401 to use a lock-free circular queue for inter-thread communication. In processing block 411 all the head indices and the tail index are initialized to zero. If in processing block 412 a producer thread is attempting to enqueue data, then processing proceeds to processing block 414. Otherwise processing proceeds to processing block 432 where it is determined if a consumer thread is attempting to dequeue data. As described above, processing repeats in processing blocks 412 and 432 until one of these two cases is satisfied.

Assuming that in processing block 412 a producer thread is attempting to enqueue data, then j is initialized to zero (0) in processing block 413 and in processing block 414 a comparison is performed between the queue tail index and each queue head j index to see if they differ by exactly one modulo the queue size and incrementing the tail index would cause a queue overflow, in which case the circular queue is already full. The comparison is repeated for all the head j indices incrementing j in processing block 416 until j reaches n (the number of consumer threads) in processing block 417. If the queue is not already full, the comparisons in processing block 414 indicate that there is sufficient room available in the queue for at least one more queue entry, and so a single producer thread is permitted to perform an atomic write operation to an aligned queue entry in memory in processing block 418 and then to update the queue tail index starting in processing block 419. Otherwise the producer thread is denied an enqueue access in processing block 415 and processing returns to processing block 412.

Starting in processing block 419, updating the circular queue tail index begins with saving the tail value to a temporary storage, and in processing block 420, comparing the tail to see if it has reached the maximum queue index. If so, the temporary storage value is reset to a value of minus one (−1) in processing block 421. Otherwise processing skips directly to processing block 422 where the temporary storage value is incremented and stored to the circular queue tail index, thus completing the update of the queue tail index with an atomic write operation. Then from processing block 450 processing returns to processing block 412 with an indication that an access to the queue has been permitted.

Alternatively assuming that in processing block 432 a consumerᵢ thread is attempting to dequeue data, then in processing block 434 a comparison is made between the queue tail index and the queue headᵢ index to see if they are equal, in which case the circular queue is empty and there is no entry for the consumer thread to dequeue. It will be appreciated that each consumerᵢ may be associated with a distinct queue headᵢ index and hence may be permitted concurrent access with other consumers to the circular queue. If the queue is not empty, the comparison in processing block 434 would indicate that the queue contains at least one valid queue entry and so the consumer thread is permitted to perform an atomic read operation from an aligned entry in the circular queue in processing block 438 and to update the queue headᵢ index starting in processing block 439. Otherwise the consumer thread is denied a dequeue access in processing block 435 and processing returns to processing block 412.

Starting in processing block 439, updating the circular queue headᵢ index begins with saving the headᵢ index value to a temporary storage and, in processing block 440, comparing the headᵢ index to see if it has reached the maximum queue index value. If so, the temporary storage value is reset to a value of minus one (−1) in processing block 441. Otherwise processing skips directly to processing block 442 where the temporary storage value is incremented and stored to the circular queue headᵢ index, thus completing the update of queue headᵢ index with an atomic write operation. Then from processing block 450 processing returns to processing block 412 with an indication that access to the queue has been permitted.

Again, it will be appreciated that in some embodiments each consumerᵢ thread can be associated with a distinct queue headᵢ index, and so multiple consumers threads may also be permitted concurrent access to the circular queue. Whenever the comparison in processing block 434 would indicate that the queue contains at least one valid queue entry, that consumers thread is permitted to perform an atomic read operation from an aligned entry in the circular queue in processing block 438 and to update their respective queue headᵢ index starting in processing block 439. Otherwise that consumer thread is denied a dequeue access in processing block 435 and processing returns to processing block 412.

It will be appreciated that processes 301 and 401 relies only upon inherent atomic aligned read/write memory accesses in the multiprocessing system, and so they avoid critical sections or special purpose atomic CAS primitives and/or thread scheduler coordination. Therefore, a higher performance level is achieved for inter-thread communication due to their reduced overhead in producer/consumer thread accesses to the queue.

The above description is intended to illustrate preferred embodiments of the present invention. From the discussion above it should also be apparent that especially in such an area of technology, where growth is fast and further advancements are not easily foreseen, the invention can may be modified in arrangement and detail by those skilled in the art without departing from the principles of the present invention within the scope of the accompanying claims and their equivalents.

What is claimed is:

1. A method for inter-thread communication in a multiprocessing system, the method comprising:
permitting a single producer thread to perform an atomic aligned write operation to a circular queue and then to update a queue tail index whenever a comparison between the queue tail index and each queue head index indicates that there is sufficient room available in the queue for at least one more queue entry but denying the single producer thread an enqueue access otherwise; and
permitting a first consumer thread to perform an atomic aligned read operation from the circular queue and to update a first queue head index whenever a comparison between the queue tail index and the first queue head index indicates that the queue contains at least one valid queue entry, but denying the first consumer thread a dequeue access otherwise.

2. The method of claim 1 further comprising:
permitting a second consumer thread to perform an atomic aligned read operation from the circular queue and then to update a second queue head index, different from the first queue head index, whenever a comparison between the queue tail index and the second queue head index indicates that the queue contains at least one valid queue entry, but denying the second consumer thread a dequeue access otherwise.

3. The method of claim 2 wherein said comparison between the queue tail index and each queue head index indicates that there is sufficient room available in the queue for at least one more queue entry if no queue head index is exactly one more than the queue tail index modulo the queue size.

4. The method of claim 3 wherein said comparison between the queue tail index and the second queue head index indicates that the queue contains at least one valid queue entry if the queue tail index and the second queue head index are not equal.

5. An article of manufacture comprising
a machine-accessible medium including data that, when accessed by a machine, cause the machine to perform the method of claim 4.

6. An article of manufacture comprising:
a machine-accessible medium including data and instructions for inter-thread communication such that, when accessed by a machine, cause the machine to:
permit a single producer thread to perform an atomic aligned write operation to a circular queue and then to update a queue tail index whenever a comparison between the queue tail index and each queue head index indicates that there is sufficient room available in the queue for at least one more queue entry, but deny the single producer thread an enqueue access otherwise; and
permitting a first consumer thread to perform an atomic aligned read operation from the circular queue and to update a first queue head index whenever a comparison between the queue tail index and the first queue head index indicates that the queue contains at least one valid queue entry, but deny the first consumer thread a dequeue access otherwise.

7. The article of manufacture of claim 6, said machine-accessible medium including data and instructions such that, when accessed by the machine, causes the machine to:
permit a second consumer thread to perform an atomic aligned read operation from the circular queue and then to update a second queue head index, different from the first queue head index, whenever a comparison between the queue tail index and the second queue head index indicates that the queue contains at least one valid queue entry, but deny the second consumer thread a dequeue access otherwise.

8. The article of manufacture of claim 6 wherein said comparison between the queue tail index and each queue head index indicates that there is sufficient room available in the queue for at least one more queue entry if no queue head index is exactly one more than the queue tail index modulo the queue size.

9. The article of manufacture of claim 6 wherein said comparison between the queue tail index and the first queue head index indicates that the queue contains at least one valid queue entry if the queue tail index and the first queue head index are not equal.

10. A computing system comprising:
an addressable memory to store data in a circular queue including a queue tail index and one or more queue head indices, and to also store machine executable instructions for accessing the circular queue;
a magnetic storage device to store a copy of the machine executable instructions for accessing the circular queue; and
a multiprocessor including a producer thread and a first consumer thread, the multiprocessor operatively coupled with the addressable memory and responsive to said machine executable instructions for accessing the circular queue, to:
permit the producer thread to perform an atomic aligned write operation to the circular queue and then to update the queue tail index whenever a comparison between the queue tail index and each queue head index of the one or more queue head indices indicates that there is sufficient room available in the queue for at least one more queue entry, but deny the producer thread an enqueue access otherwise; and
permit the first consumer thread to perform an atomic aligned read operation from the circular queue and to update a first queue head index of the one or more queue head indices whenever a comparison between the queue tail index and the first queue head index indicates that the queue contains at least one valid queue entry, but deny the first consumer thread a dequeue access otherwise.

11. The system of claim 10, said multiprocessor including a second consumer thread and responsive to said machine executable instructions for accessing the circular queue, to:
permit the second consumer thread to perform an atomic aligned read operation from the circular queue and to update a second queue head index of the one or more queue head indices, whenever a comparison between the queue tail index and the second queue head index indicates that the queue contains at least one valid queue entry, but deny the second consumer thread a dequeue access otherwise.

12. The system of claim 11 wherein said comparison between the queue tail index and each queue head index indicates that there is sufficient room available in the queue for at least one more queue entry if no queue head index is exactly one more than the queue tail index modulo the queue size.

13. The system of claim 10 wherein said comparison between the queue tail index and the second queue head index indicates that the queue contains at least one valid queue entry if the queue tail index and the second queue head index are not equal.
